(19) United States
(12) Patent Application Publication
(10) Pub. No.: US 2013/0019591 A1
(43) Pub. Date: Jan. 24, 2013

(54) Energy Generation System Using Underwater Storage of Compressed Air Produced by Wind Machines

(71) Applicant: Herbert L. Williams, Palatka, FL (US)

(72) Inventor: Herbert L. Williams, Palatka, FL (US)

(21) Appl. No.: 13/552,984

(22) Filed: Jul. 19, 2012

Related U.S. Application Data
(60) Provisional application No. 61/572,703, filed on Jul. 20, 2011.

(51) Int. Cl. F03D 9/02; F01D 1/00; F03D 11/02

(52) U.S. Cl. 60/398

(57) ABSTRACT

An offshore floating wind farm producing compressed air in varying quantities depending on the wind speed, the compressed air being delivered to a large-volume, thin-walled, underwater storage bladder or tank, the compressed air then being delivered to an electricity-generating power plant to power generators as needed. The system may also include an onshore wind farm that produces compressed air in varying quantities depending on wind speed, the compressed air being delivered directly to the power plant. When compressed air production exceeds the needs of the power plant, the excess compressed air is delivered to the underwater storage tank. When onshore production is inadequate, compressed air is brought from the underwater storage tank to the power plant.

This application claims the benefit of U.S. Provisional Patent Application Ser. No. 16/572,703, filed Jul. 20, 2011.

### BACKGROUND OF THE INVENTION

This invention relates generally to the field of energy generation systems, and in particular to systems utilizing wind turbines to create compressed air stored in tanks, the compressed air being utilized to drive electrical generators.

A major alternative energy source is the use of wind turbines or wind machines, whereby large, bladed, rotor assemblies turned by wind currents are used to power electrical generators, either by directly turning the rotational members of the generators or by the production of compressed air which is then used to turn the rotational members of the generators. It is known to congregate large numbers of wind machines to form wind farms, and it is known to have the wind machines directly powering air compressors instead of dedicated generators. The compressed air is produced in varying amounts depending on wind velocity and is stored in large tanks to be released at a constant rate to power the electrical generators.

The invention is a system for maximizing the production and storage of compressed air using wind farms, particularly offshore wind farms, as well as the efficiency of power plants having turbine generators powered by the stored compressed air.

### SUMMARY OF THE INVENTION

The invention comprises in general an energy generation system utilizing underwater storage of compressed air produced by wind machines. The system comprises an offshore floating wind farm producing compressed air in varying quantities depending on the wind speed, the compressed air being pumped down to a submerged, thin-walled, bladder tank for accumulation and storage, the compressed air then being delivered through a conduit to an electricity-generating power plant to power generators, the deep water pressure providing the delivery force. The system preferably further comprises an onshore wind farm that produces compressed air in varying quantities depending on wind speed, the compressed air being delivered directly to the power plant. When compressed air production by the onshore wind farm exceeds the needs of the power plant, the excess compressed air is delivered to the underwater bladder tank. When onshore production is inadequate, compressed air is brought from the underwater storage tank.

### BRIEF DESCRIPTION OF THE DRAWINGS

FIG. 1 is a representative illustration of an embodiment of the energy generation system utilizing underwater storage of compressed air produced by wind machines

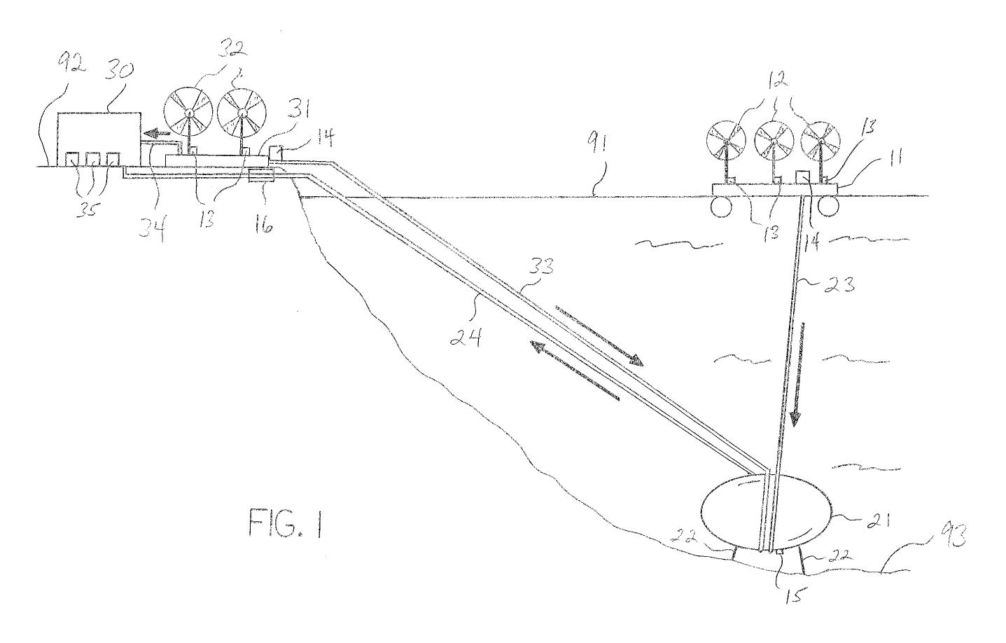

### DETAILED DESCRIPTION OF THE INVENTION

With reference to the drawings, the invention will now be described in detail. In a general sense, the system comprises an offshore floating wind farm producing compressed air in varying quantities depending on the wind speed, the compressed air being then delivered to a thin-walled, underwater bladder tank for accumulation, storage and subsequent delivery at a generally constant rate to an electricity-generating power plant to power generators. The bladder tank is submerged a sufficient distance under the water surface such that the water pressure compresses the walls of the tank sufficiently to deliver the compressed air to the power plant without the need for pumping equipment to perform this task. The system preferably further comprises an onshore wind farm that produces compressed air in varying quantities depending on wind speed, the compressed air being delivered directly to the power plant. When compressed air production by the onshore wind farm exceeds the needs of the power plant, the excess compressed air is delivered to the underwater bladder tank for later use. When onshore production is inadequate, stored compressed air is delivered to the power plant from the underwater bladder tank.

As shown in the drawing, the system comprises an onshore electricity-generating power plant 30 in which turbines or similar electrical generators 35 are used to generate electricity which is then distributed to consumers. The generators 35 are of the type powered by compressed air, such being well known the industry. The power plant 30 is preferably located near or adjacent a large body of water 91, such as the ocean or a deep river or lake.

A floating wind farm 11 is positioned in the body of water 91 a significant distance from shore to take advantage of offshore wind currents, which in many locations are much stronger, more frequent and steadier than onshore wind currents. The floating wind farm 11 comprises a plurality of wind machines 12 and the wind farm 11 is set up such that the wind machines 12 produce compressed air in known manner, i.e., rotation of the blade assemblies of the wind machines 12 operates compressors 13 that deliver air into a tank under pressure, the compressed air in this instance being delivered through a descending supply pipe, hose or conduit 23 into a submerged bladder tank 21 of large capacity. Pumping equipment 14 may be utilized if necessary to deliver the air to the bladder tank 21.

The submerged bladder tank 21 is a substantially thin-walled structure, possibly constructed with rigid framing or base members, the bladder tank 21 having walls composed of a material that is non-rigid and highly flexible, or even elastic, such that the bladder tank 21 is readily expandable form a low volume state to a high volume state by introduction of the compressed air from the floating wind farm 11 into the tank 21. The bladder tank 21 is positioned deep within the body of water 91 or directly on the floor 93 of the body of water 91 using anchors or similar tethering members 22 such that the bladder tank 21 is exposed to high external pressure from the weight of the water, preferably on all sides of the bladder tank 21. The depth of the bladder tank 21 determines the amount of pressure encountered, there being an increase over surface or atmospheric pressure of approximately 4 psi for every ten feet of depth the bladder tank 21 is positioned below the water surface. A delivery or output pipe, hose or conduit 24 extends from the bladder tank 21 to the power plant 30. The compressed air produced by the wind farm 11 is delivered into the submerged bladder tank 21, overcoming the underwater pressure and filling the bladder tank 21. This is readily accomplished because relatively small amounts of compressed air are delivered to the bladder tank 21 at any given time. Initial submersion of the bladder tank 21 can be accomplished by submerging a bladder tank 21 with collapsed walls or by introducing water into the bladder tank 21 to provide weight. Once anchored or otherwise secured underwater, compressed air is introduced into the bladder tank 21 and will displace any water in the bladder tank 21 through one-way check valves 15. The air will be delivered from the wind farm 11 at varying flow rates depending on the wind velocity encountered offshore, and there may be times where no compressed air is produced if wind speeds are minimal or non-existent.

Once the submerged bladder tank 21 is sufficiently full the external underwater pressure will be sufficient to force the air through delivery conduit 24 to the onshore power plant 30, the outflow being controlled with flow control valves and restrictors 16 in known manner such that the outflow is delivered at a steady and constant rate to run the generators 35 within the onshore power plant 30. In this manner a constant and extended supply of compressed air can be delivered from the bladder tank 21 to the power plant 30 regardless of the variation in wind current. When the wind current is strong enough offshore, the air in the bladder tank 21 is replenished.

In a preferred embodiment, an onshore wind farm 31 comprising wind machines 32 and air compressors 13 may be situated near the power plant 30. Compressed air produced by the onshore wind farm 31 is delivered directly to the power plant 30 through delivery conduit 34, and the onshore wind farm 31 becomes the primary power source and the offshore wind farm 11 becomes the secondary power source. If the onshore wind farm 31 is producing sufficient compressed air there is no need to draw air from the underwater bladder tank 21. If onshore production is inadequate, compressed air is brought from the underwater bladder tank 21 to supplement or replace the onshore supply. If the onshore wind farm 31 is producing more compressed air than is needed at a particular time, the excess is delivered through auxiliary supply conduit 33 to the underwater bladder tank 21, pumping equipment 14 being utilized if necessary, where it is stored for later use.

It is understood that equivalents and substitutions for certain elements described above may be obvious to those of ordinary skill in the art, and therefore the true scope and definition of the invention is to be as set forth in the following claims.

I claim:

1. An energy generating system comprising in combination:
an offshore floating wind farm comprising wind machines and air compressors operated by said wind machines to produce compressed air;
a submerged bladder tank;
a descending supply conduit connecting said air compressors of said offshore wind farm to said tank and through which said compressed air is delivered to said bladder tank;
an onshore power plant comprising generators operated by compressed air; and
a delivery conduit connecting said bladder tank to said power plant and through which said compressed air stored in said bladder tank is delivered to said generators of said power plant;
whereby said compressed air produced by said air compressors of said offshore wind farm is delivered into said bladder tank for storage, and whereby said compressed air in said bladder tank is subsequently delivered to said generators of said power plant by water pressure acting on said bladder tank.

2. The system of claim 1 further comprising:
an onshore wind farm comprising wind machines and air compressors operated by said wind machines to produce compressed air;
a delivery conduit connecting said air compressors of said onshore wind farm to said generators of said power plant and through which compressed air produced by said air compressors of said onshore wind farm is delivered to said generators of said power plant; and
an auxiliary supply conduit connecting said air compressors of said onshore wind farm to said bladder tank and through which excess compressed air produced by said air compressors of said onshore wind farm is delivered into said bladder tank.

3. The system of claim 1, said offshore wind farm further comprising pumping equipment, said pumping equipment of said offshore wind farm delivering said compressed air through said supply conduit to said bladder tank.

4. The system of claim 2, said offshore wind farm further comprising pumping equipment, said pumping equipment of said offshore wind farm delivering said compressed air through said supply conduit to said bladder tank.

5. The system of claim 2, said onshore wind farm further comprising pumping equipment, said pumping equipment of said onshore wind farm delivering said compressed air through said auxiliary supply conduit to said bladder tank.

6. The system of claim 4, said onshore wind farm further comprising pumping equipment, said pumping equipment of said onshore wind farm delivering said compressed air through said auxiliary supply conduit to said bladder tank.

7. The system of claim 1, said bladder tank comprising non-rigid, flexible walls.

8. The system of claim 1, said bladder tank comprising non-rigid, elastic walls.

9. The system of claim 2, said bladder tank comprising non-rigid, flexible walls.

10. The system of claim 2, said bladder tank comprising non-rigid, elastic walls.

11. An energy generating system comprising in combination:
an offshore floating wind farm comprising wind machines and air compressors operated by said wind machines to produce compressed air;
a submerged bladder tank comprising non-rigid, flexible walls and capable of storing compressed air;
a descending supply conduit connecting said air compressors of said offshore wind farm to said tank and through which said compressed air is delivered to said bladder tank;
an onshore power plant comprising generators operated by compressed air; and
a delivery conduit connecting said bladder tank to said power plant and through which said compressed air stored in said bladder tank is delivered to said generators of said power plant;
whereby said compressed air produced by said air compressors of said offshore wind farm is delivered into said bladder tank for storage, and whereby said compressed air in said bladder tank is subsequently delivered to said generators of said power plant by water pressure acting on said bladder tank;
an onshore wind farm comprising wind machines and air compressors operated by said wind machines to produce compressed air;
a delivery conduit connecting said air compressors of said onshore wind farm to said generators of said power plant and through which compressed air produced by said air compressors of said onshore wind farm is delivered to said generators of said power plant; and
an auxiliary supply conduit connecting said air compressors of said onshore wind farm to said bladder tank and through which excess compressed air produced by said air compressors of said onshore wind farm is delivered into said bladder tank.

12. The system of claim 11, said offshore wind farm further comprising pumping equipment, said pumping equipment of said offshore wind farm delivering said compressed air through said supply conduit to said bladder tank.

13. The system of claim 12, said onshore wind farm further comprising pumping equipment, said pumping equipment of said onshore wind farm delivering said compressed air through said auxiliary supply conduit to said bladder tank.
